(19) United States
(12) Patent Application Publication
(10) Pub. No.: US 2018/0129032 A1
(43) Pub. Date: May 10, 2018

(54) ENDOSCOPE OBSERVATION SYSTEM, AND INSERTION GUIDE AND HOLDING MEMBER OF ENDOSCOPE OBSERVATION SYSTEM

(71) Applicant: OLYMPUS CORPORATION, Tokyo (JP)

(72) Inventors: Daiki ARIYOSHI, Tokyo (JP); Atsuyoshi Shimamoto, Tokyo (JP); Soichiro Koshika, Tokyo (JP)

(73) Assignee: OLYMPUS CORPORATION, Tokyo (JP)

(21) Appl. No.: 15/346,852

(22) Filed: Nov. 9, 2016

(51) Int. Cl. G02B 23/24; H04N 5/232

(52) U.S. Cl. CPC G02B 23/2484; G02B 23/2469; H04N 5/2328

(57) ABSTRACT

An endoscope observation system includes: a scanning type endoscope including an emission optical fiber configured to emit emission light from an emission end, an actuator configured to cause the emission end to swing, a protection pipe with the emission optical fiber and the actuator attached inside, and a light receiving portion positioned at a distal end portion; an insertion guide configured to guide insertion of the scanning type endoscope into the object along a guide wall; and a holding member arranged between the scanning type endoscope and the guide wall and configured to hold the scanning type endoscope so that a position of the scanning type endoscope is not displaced by swinging of the emission optical fiber.

### BACKGROUND OF THE INVENTION

### 1. Field of the Invention

The present invention relates to an endoscope observation system, and an insertion guide and a holding member of the endoscope observation system.

### 2. Description of the Related Art

Conventionally, there have been medical treatment instruments into which an endoscope having an image pickup device at a distal end portion can be inserted, for example, as disclosed in Japanese Patent Application Laid-Open Publication No. 2015-109886.

Further, as another conventional example, there is a scanning type endoscope causing an emission optical fiber to swing in a distal end portion and scanning an object along a predetermined scan route by emission light emitted from the emission optical fiber to acquire an observation image. Since the scanning type endoscope does not have an image pickup device in the distal end portion, a diameter can be reduced.

In the scanning type endoscope, when the emission optical fiber swings, the distal end portion swings based on a predetermined vibration pattern in response to a motion of the emission optical fiber. Therefore, the predetermined scan route is set in advance in consideration of the vibration of the distal end portion based on the predetermined vibration pattern so that an observation image is not disturbed.

### SUMMARY OF THE INVENTION

An endoscope observation system of an aspect of the present invention includes: a scanning type endoscope including an emission optical fiber configured to emit emission light incident from an incident end, from an emission end, an actuator configured to cause the emission end to swing, a protection pipe with the emission optical fiber and the actuator attached inside, and a light receiving end configured to receive return light from an object and positioned at a distal end portion; an insertion guide configured to guide insertion of the scanning type endoscope into the object along a guide wall; and a holding member arranged between the scanning type endoscope and the guide wall and configured to hold the scanning type endoscope so that a position of the scanning type endoscope is not displaced by swinging of the emission optical fiber.

An insertion guide of the endoscope observation system of the aspect of the present invention holds a scanning type endoscope including an emission optical fiber configured to emit emission light incident from an incident end, from an emission end, an actuator configured to cause the emission end to swing, a protection pipe with the emission optical fiber and the actuator attached inside, and a light receiving end configured to receive return light from an object and positioned at a distal end portion, by a holding member so that a position of the scanning type endoscope is not displaced by swinging of the emission optical fiber, and guides insertion of the scanning type endoscope into the object along a guide wall.

A holding member of the endoscope observation system of the aspect of the present invention is arranged between a scanning type endoscope including an emission optical fiber configured to emit emission light incident from an incident end, from an emission end, an actuator configured to cause the emission end to swing, a protection pipe with the emission optical fiber and the actuator attached inside, and a light receiving end configured to receive return light from an object and positioned at a distal end portion and a guide wall of an insertion guide configured to guide insertion of the scanning type endoscope into the object, and the holding member holds the scanning type endoscope so that a position of the scanning type endoscope is not displaced by swinging of the emission optical fiber.

### BRIEF DESCRIPTION OF THE DRAWINGS

FIG. 1 is a block diagram showing a configuration example of an endoscope observation system according to an embodiment of the present invention;

FIG. 2 is a cross-sectional view showing a configuration example of a scanning type endoscope and an insertion guide of the endoscope observation system according to the embodiment of the present invention;

FIG. 3 is a cross-sectional view showing a configuration example of a distal end portion of the scanning type endoscope and a distal end portion of the insertion guide of the endoscope observation system according to the embodiment of the present invention;

FIG. 4 is a cross-sectional view showing a configuration example of an actuator of the endoscope observation system according to the embodiment of the present invention;

FIG. 5 is a diagram illustrating an example of a scan route of the endoscope observation system according to the embodiment of the present invention;

FIG. 6 is a diagram illustrating an example of the scan route of the endoscope observation system according to the embodiment of the present invention;

FIG. 7 is a perspective view showing an example of a holding member of the endoscope observation system according to the embodiment of the present invention;

FIG. 8 is a front view showing a configuration example of an insertion guide and a holding member of an endoscope observation system according to a first modification of the embodiment of the present invention;

FIG. 9 is a front view showing a configuration example of an insertion guide and a holding member of an endoscope observation system according to a second modification of the embodiment of the present invention;

FIG. 10 is a cross-sectional view showing a configuration example of a distal end portion of a scanning type endoscope and a distal end portion of an insertion guide of an endoscope observation system according to a third modification of the embodiment of the present invention; and

FIG. 11 is a cross-sectional view showing a configuration example of a distal end portion of a scanning type endoscope and a distal end portion of an insertion guide of an endoscope observation system according to a fourth modification of the embodiment of the present invention.

### DETAILED DESCRIPTION OF THE PREFERRED EMBODIMENT

### Embodiment

An embodiment will be described below with reference to drawings.

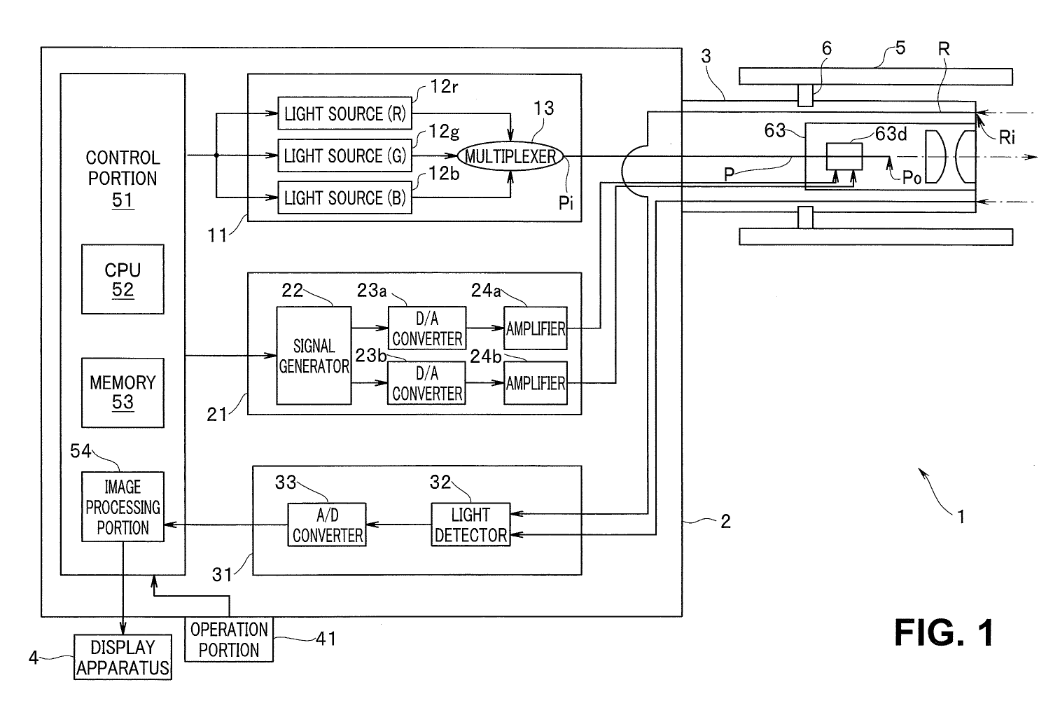

FIG. 1 is a block diagram showing a configuration example of an endoscope observation system 1 according to the embodiment of the present invention.

The endoscope observation system 1 is configured including an endoscope processor 2, a scanning type endoscope 3, a display apparatus 4, an insertion guide 5 and a holding member 6. The scanning type endoscope 3 and the display apparatus 4 are detachably connected to the endoscope processor 2. The scanning type endoscope 3 is inserted into the insertion guide 5 and held by the holding member 6.

The endoscope processor 2 is configured including a light source unit 11, a driver unit 21, a detection unit 31, an operation portion 41 and a control portion 51.

The light source unit 11 sequentially outputs laser lights generated from laser light sources 12r, 12g and 12b for red, green and blue, respectively, to an emission optical fiber P via a multiplexer 13 based on a control signal inputted from the control portion 51 as emission light.

The emission optical fiber P has an incident end Pi on which emission light is incident and an emission end Po which emits the emission light to an object. The emission optical fiber P guides the emission light incident from the incident end Pi to the emission end Po and emits the emission light to the object from the emission end Po.

The driver unit 21 is a circuit configured to drive an actuator 63d to be described later and cause the emission end Po of the emission optical fiber P to swing. The driver unit 21 is configured including a signal generator 22, D/A converters 23a and 23b, and amplifiers 24a and 24b.

The signal generator 22 generates drive signals Dx and Dy to drive the actuator 63d based on a control signal inputted from the control portion 51 and outputs the drive signals Dx and Dy to the D/A converters 23a and 23b.

The drive signal Dx is outputted so that the emission end Po of the emission optical fiber P can be swung in an X axis direction to be described later. The drive signal Dx is defined, for example, by an equation (1) below. In the equation (1), X(t) denotes a signal level of the drive signal Dx at time t; Ax denotes an amplitude value not depending on the time t; and G(t) denotes a predetermined function to modulate a sine wave sin(2πft).

X(t)=Ax×G(t)×sin(2πft) (1)

The drive signal Dy is outputted so that the emission end Po of the emission optical fiber P can be swung in a Y axis direction to be described later. The drive signal Dy is defined, for example, by an equation (2) below. In the equation (2), Y(t) denotes a signal level of the drive signal Dy at the time t; Ay denotes an amplitude value not depending on the time t; G(t) denotes a predetermined function to modulate a sine wave sin(2πft+ϕ); and ϕ denotes a phase.

Y(t)=Ay×G(t)×sin(2πft+ϕ) (2)

The D/A converters 23a and 23b convert the drive signals Dx and Dy inputted from the signal generator 22 from digital signals to analog signals, respectively, and output the drive signals Dx and Dy to the amplifiers 24a and 24b.

The amplifiers 24a and 24b amplify the drive signals Dx and Dy inputted from the D/A converters 23a and 23b and output the amplified drive signals Dx and Dy to the actuator 63d.

The detection unit 31 is a circuit configured to detect return light which returns from an object and output detection signals corresponding to the return light to the control portion 51. The detection unit 31 is configured including a light detector 32 and an A/D converter 33.

The light detector 32 is configured including a photoelectric conversion device, and the light detector 32 converts return light of an object inputted via a light receiving fiber R to red, green and blue detection signals and outputs the detection signals to the A/D converter 33.

The A/D converter 33 converts the detection signals inputted from the light detector 32 to digital signals and outputs the digital signals to the control portion 51.

The operation portion 41 is connected to the control portion 51 and is configured to be able to output a user's instruction input to the control portion 51.

The control portion 51 is configured to be able to control an operation of each portion in the endoscope observation system 1. The control portion 51 has a central processing unit (hereinafter referred to as a “CPU”) 52, a memory 53 including a ROM and a RAM, and an image processing portion 54. Functions of the processing portions of the control portion 51 are realized by various programs stored in the memory 53 being executed by the CPU 52.

In the memory 53, a program configured to control the operation of each portion in the endoscope observation system 1 is stored.

The image processing portion 54 is a circuit configured to generate an observation image based on digitalized detection signals outputted from the detection unit 31. More specifically, the image processing portion 54 performs mapping processing based on a mapping table not shown, for red, green and blue detection signals acquired along a predeteiluined scan route to generate a raster format observation image and outputs the observation image to the display apparatus 4.

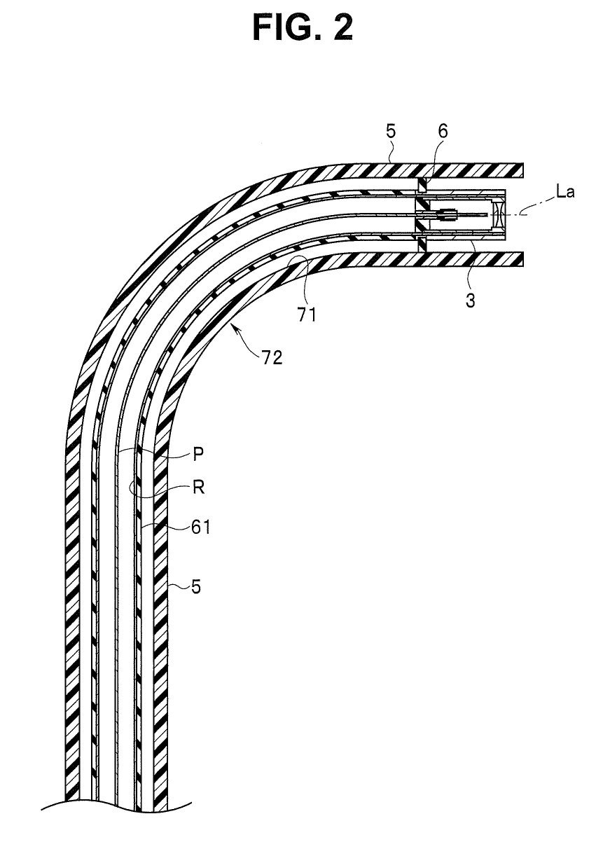

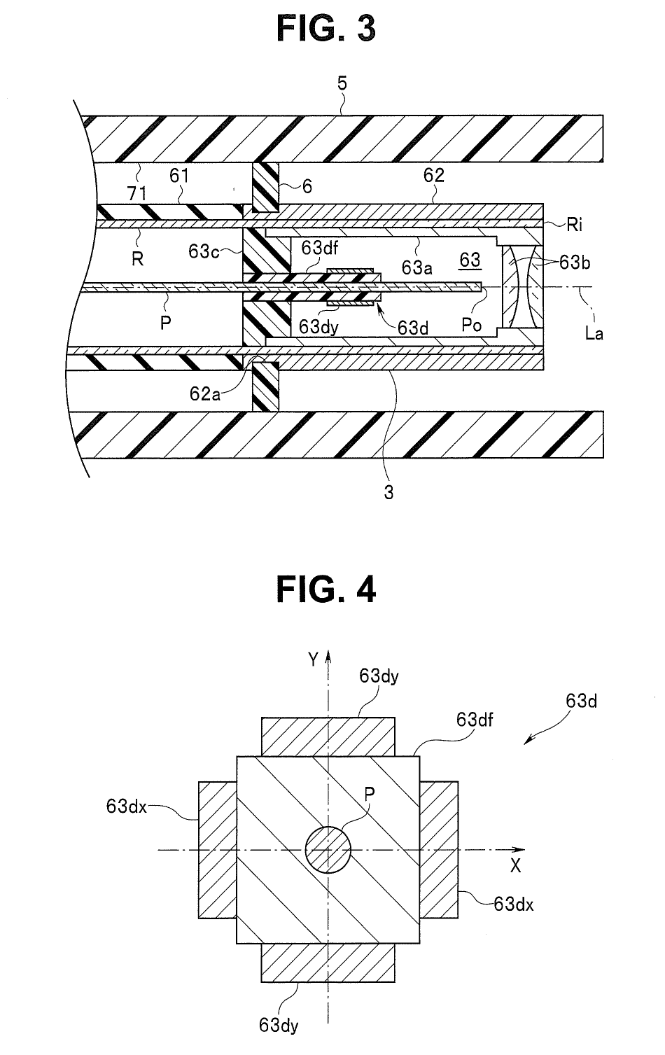

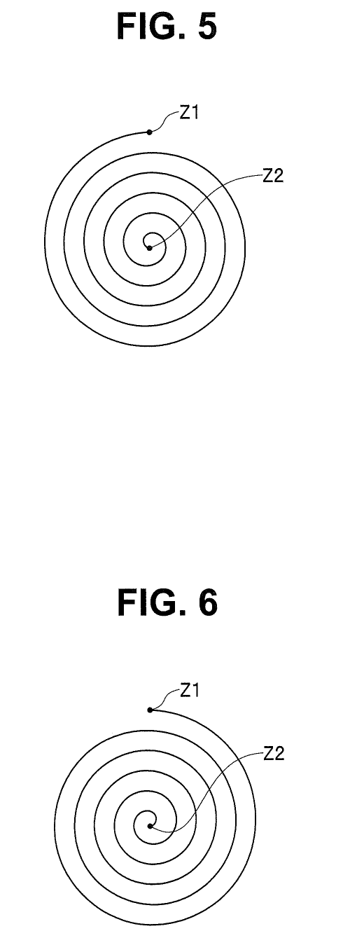

FIG. 2 is a cross-sectional view showing a configuration example of the scanning type endoscope 3 and the insertion guide 5 of the endoscope observation system 1 according to the embodiment of the present invention. FIG. 3 is a cross-sectional view showing a configuration example of a distal end portion of the scanning type endoscope 3 and a distal end portion of the insertion guide 5 of the endoscope observation system 1 according to the embodiment of the present invention. In FIGS. 2 and 3, the scanning type endoscope 3 and the insertion guide 5 are cut along a central axis La. FIG. 4 is a cross-sectional view showing a configuration example of the actuator 63d of the endoscope observation system 1 according to the embodiment of the present invention. In FIG. 4, the X axis direction is a direction orthogonal to the central axis La of the emission optical fiber P, and the Y axis direction is a direction orthogonal to the central axis La of the emission optical fiber P and the X axis direction. FIGS. 5 and 6 are diagrams illustrating an example of the scan route of the endoscope observation system 1 according to the embodiment of the present invention.

The scanning type endoscope 3 is inserted into the insertion guide 5 as shown in FIG. 2. The scanning type endoscope 3 is configured to be guided by the insertion guide 5 and inserted into an object so as to be able to emit light emitted by the light source unit 11 to the object and receive return light of the object.

As shown in FIG. 3, the distal end portion of the scanning type endoscope 3 has an outer cover 61, an outer pipe 62, the light receiving fiber R and a light emitting portion 63.

The outer cover 61 is configured with flexible material such as rubber and fottned in a tube shape. The outer cover 61 accommodates the emission optical fiber P and the light receiving fiber R inside. A proximal end of the outer cover 61 is attached to the endoscope processor 2, and a distal end is attached to the outer pipe 62.

The outer pipe 62 is configured with material such as stainless steel. The outer pipe 62 is attached to the distal end of the outer cover 61. An attaching recess portion 62a to which the holding member 6 is attached is provided on the outer pipe 62. In the embodiment, the attaching recess portion 62a is formed in a shape of a circumferential groove surrounding an outer circumference of the outer pipe 62 as an example.

The light receiving fiber R is configured so that return light from an object can be received by a light receiving end Ri. The light receiving fiber R is arranged between the outer pipe 62 and a protection pipe 63a. The light receiving fiber R is connected to the detection unit 31, and the light receiving fiber R guides light received by the light receiving end Ri and outputs the light to the detection unit 31.

The light emitting portion 63 is configured so that emission light can be emitted to an object. The light emitting portion 63 has the protection pipe 63a, an optical system 63b, a holding portion 63c and the actuator 63d.

The protection pipe 63a is configured with material such as metal and fotmed in a pipe shape. The emission optical fiber P and the actuator 63d are attached inside of the protection pipe 63a .

The optical system 63b is configured so that emission light can be condensed and emitted to an object. The optical system 63b is configured with two plano-convex lenses. Note that, though the optical system 63b is attached in the protection pipe 63a in FIG. 3, the optical system 63b may be attached to a lens barrel not shown and attached to the protection pipe 63a via the lens barrel. Further, though the optical system 63b is configured with the two plano-convex lenses in FIG. 3, the optical system 63b is not limited to the configuration and may be configured with other lenses.

The holding portion 63c is configured with material such as resin and metal. A ferrule 63df is inserted into the holding portion 63c, and the holding portion 63c is attached to a proximal end of the protection pipe 63a so that the emission optical fiber P and the actuator 63d can be held in a cantilever beam shape.

The actuator 63d is configured to cause the emission end Po to swing so that an emission position of emission light can be moved along a predetermined scan route. The predetermined scan route is, for example, a spiral scan route to be described later. The actuator 63d has the ferrule 63df and piezoelectric devices 63dx and 63dy. The ferrule 63df is configured with material such as zirconia (ceramics). The ferrule 63df fixes an outer circumference of the emission optical fiber P so that the emission end Po can be caused to swing.

As shown in FIG. 4, the piezoelectric devices 63dx and 63dy are arranged on an outer circumference of the ferrule 63df and connected to the driver unit 21 and configured to vibrate in response to the drive signals Dx and Dy inputted from the driver unit 21 so that the emission end Po can be caused to swing. The emission end Po swings in the X axis direction by the piezoelectric device 63dx and swings in the Y axis direction by the piezoelectric device 63dy.

When the driver unit 21 outputs the drive signal Dx and Dy while increasing signal levels, the emission optical fiber P is swung by the actuator 63d, and an emission position of the emission optical fiber P moves along a spiral scan route which gradually goes far away from a center, from Z1 to Z2 as shown in FIG. 5. After that, when the driver unit 21 outputs the drive signals Dx and Dy while decreasing the signal levels, the emission position of the emission optical fiber P moves along a spiral scan route which gradually comes close to the center, from Z2 to Z1 as shown in FIG. 6. Thereby, each of red, green and blue laser lights sequentially generated by the light source unit 11 is emitted to an object in a spiral shape; return light from the object is received by the light receiving fiber R; and the object is spirally scanned.

The display apparatus 4 (FIG. 1) is connected to the control portion 51 and configured so that an observation image outputted from the image processing portion 54 can be displayed.

Returning to FIG. 2, the insertion guide 5 is insertable into an object and configured so that insertion of the scanning type endoscope 3 into the object can be guided along a guide wall 71. The insertion guide 5 is configured with material such as resin. The insertion guide 5 is formed in an elongated pipe shape, and has a bent portion 72 which is bent in advance so as to be along an insertion route of the insertion guide 5 in an object. In FIGS. 2 and 3, the guide wall 71 is an inner wall of the insertion guide 5.

That is, the insertion guide 5 holds the scanning type endoscope 3 including the emission optical fiber P configured to emit emission light incident from the incident end Pi, from the emission end Po, the actuator 63d configured to cause the emission end Po to swing, the protection pipe 63a with the emission optical fiber P and the actuator 63d attached inside, and the light receiving end Ri configured to receive return light from an object and positioned at the distal end portion so that a position of the scanning type endoscope 3 is not displaced by swinging of the emission optical fiber P, and guides insertion of the scanning type endoscope 3 into the object along the guide wall 71.

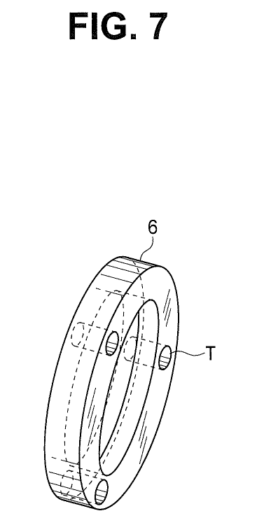

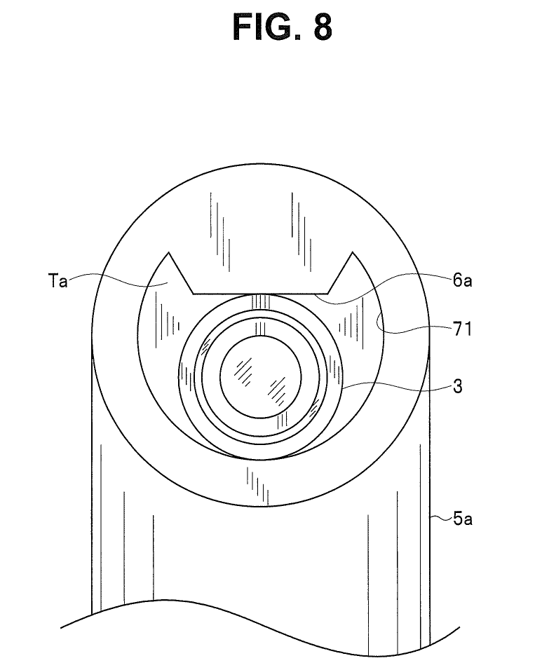

FIG. 7 is a perspective view showing an example of the holding member 6 of the endoscope observation system 1 according to the embodiment of the present invention.

The holding member 6 is arranged between an outer circumference of the scanning type endoscope 3 and the guide wall 71 and configured to hold the scanning type endoscope 3 so that the position of the scanning type endoscope 3 is not displaced by swinging of the emission optical fiber P. More preferably, the holding member 6 is provided between the outer circumference of the distal end portion of the scanning type endoscope 3 and the guide wall 71. The holding member 6 is made of material such as rubber and synthetic resin and configured with a vibration damping member for suppressing vibration of the scanning type endoscope 3. As shown in FIG. 7, for example, the holding member 6 is formed in a ring shape. The holding member 6 is detachably attached to the attaching recess portion 62a provided on the outer circumference of the distal end portion of the scanning type endoscope 3. Note that a through hole T which passes through in an axial direction may be provided on a periphery of the holding member 6.

That is, the holding member 6 is arranged between the scanning type endoscope 3 including the emission optical fiber P configured to emit emission light incident from the incident end Pi, from the emission end Po, the actuator 63d configured to cause the emission end Po to swing, the protection pipe 63a with the emission optical fiber P and the actuator 63d attached inside, and the light receiving end Ri configured to receive return light from an object and positioned at the distal end portion and the guide wall 71 of the insertion guide 5 configured to guide insertion of the scanning type endoscope 3 into the object and configured to hold the scanning type endoscope 3 so that the position of the scanning type endoscope 3 is not displaced by swinging of the emission optical fiber P.

According to the above embodiment, in the endoscope observation system 1, vibration of the distal end portion by swinging of the emission optical fiber P is suppressed by the holding member 6, and displacement of a scan route and disturbance of an observation image can be suppressed.

### First Modification of the Embodiment

Though the holding member 6 is attached to the attaching recess portion 62a of the scanning type endoscope 3 in the embodiment, the holding member 6 may be provided on an insertion guide 5a.

FIG. 8 is a front view showing a configuration example of an insertion guide 5a and a holding member 6a of the endoscope observation system 1 according to a first modification of the embodiment of the present invention. In description of the first modification, components which are same as components of the embodiment and other modifications are given same reference numerals, and description of the components will be omitted.

As shown in FIG. 8, the holding member 6a is provided on the insertion guide 5a. More specifically, the holding member 6a is integrally formed with the insertion guide 5a so that a part of the guide wall 71 projects inward.

The scanning type endoscope 3 is inserted into the insertion guide 5a and held by the holding member 6a and the guide wall 71. A gap Ta is formed between the scanning type endoscope 3 and the guide wall 71.

### Second Modification of the Embodiment

Though the scanning type endoscope 3 is held by the holding member 6a and the guide wall 71 in the first modification of the embodiment, the scanning type endoscope 3 may be held by a holding member 6b. In description of the second modification, components which are same as components of the embodiment and other modifications are given same reference numerals, and description of the components will be omitted.

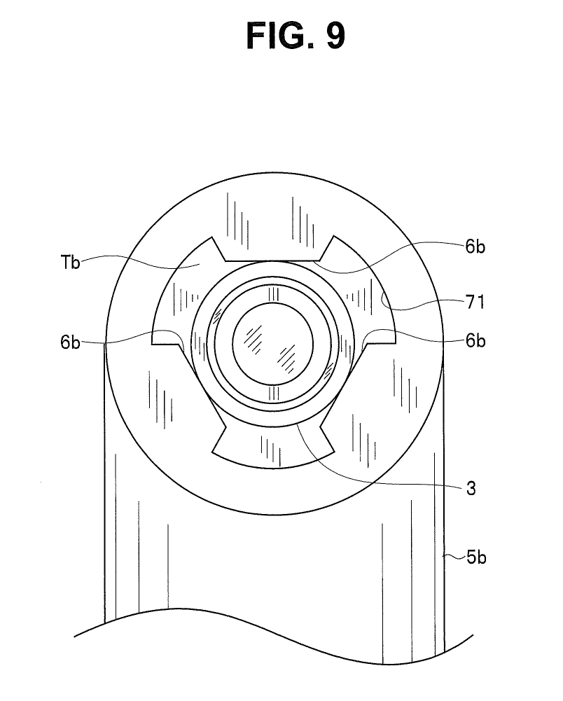

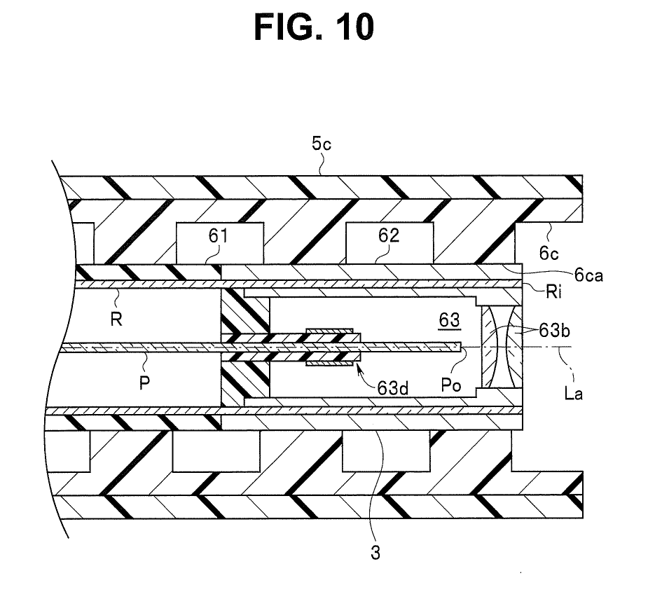

FIG. 9 is a front view showing a configuration example of an insertion guide 5b and the holding member 6b of the endoscope observation system 1 according to a second modification of the embodiment of the present invention.

As shown in FIG. 9, the holding member 6b is provided on the insertion guide 5b. More specifically, the holding member 6b is integrally formed with the insertion guide 5b so that three parts of the guide wall 71 project inward.

At least three points of the scanning type endoscope 3 are held by the holding member 6b. A gap Tb is formed between the scanning type endoscope 3 and the guide wall 71.

### Third Modification of the Embodiment

Though the holding members 6a and 6b are integrally formed with the insertion guides 5a and 5b in the first and second modifications of the embodiment, the holding members 6a and 6b may be separately formed.

FIG. 10 is a cross-sectional view showing a configuration example of the distal end portion of the scanning type endoscope 3 and a distal end portion of an insertion guide 5c of the endoscope observation system 1 according to a third modification of the embodiment of the present invention. In FIG. 10, the distal end portions of the scanning type endoscope 3 and the insertion guide 5c are cut along the central axis La. In description of the third modification, components which are same as components of the embodiment and other modifications are given same reference numerals, and description of the components will be omitted.

The insertion guide 5c has a detachable holding member 6c inside. The holding member 6c is made of material such as sponge, formed in an elongated pipe shape and fitted in the insertion guide 5c. The holding member 6c has a pressing portion 6ca.

The pressing portion 6ca is formed with the holding member 6c caused to project inside so that the pressing portion 6ca presses the scanning type endoscope 3. By the pressing portion 6ca pressing the outer circumference of the scanning type endoscope 3, the scanning type endoscope 3 is held by the holding member 6c.

That is, the holding member 6c is attached to the guide wall 71.

Note that, though the holding member 6c is made of material such as sponge in the present modification, the holding member 6c may be configured with a brush or the like. In that case, the pressing portion 6ca is configured with a distal end portion of the brush.

### Fourth Modification of the Embodiment

Though the holding member 6 is attached to the scanning type endoscope 3 in the embodiment, and the holding members 6a, 6b and 6c are provided on the insertion guides 5a, 5b and 5c in the first, second and third modifications of the embodiment, holding members 6da and 6db may be provided on a scanning type endoscope 3d and an insertion guide 5d.

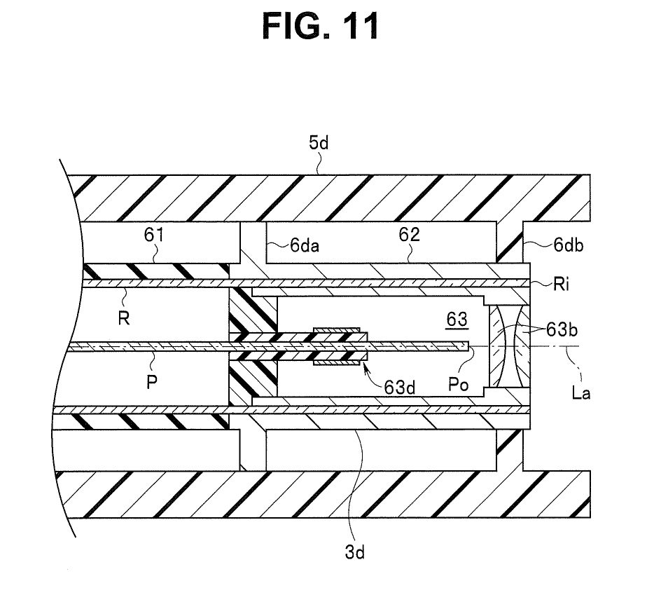

FIG. 11 is a cross-sectional view showing a configuration example of a distal end portion of the scanning type endoscope 3d and a distal end portion of the insertion guide 5d of the endoscope observation system 1 according to a fourth modification of the embodiment of the present invention. In FIG. 11, the distal end portions of the scanning type endoscope 3d and the insertion guide 5d are cut along the central axis La.

The scanning type endoscope 3d has the holding member 6da. The holding member 6da is integrally formed with the scanning type endoscope 3d so that an outer circumference of the scanning type endoscope 3d projects outward.

The insertion guide 5d has the holding member 6db. The holding member 6db is integrally formed with the insertion guide 5d so that the guide wall 71 projects inward.

Note that, though the insertion guides 5, 5a, 5b, 5c and 5d are formed in an elongated pipe shape in the embodiment and the modifications, the insertion guides 5, 5a, 5b, 5c and 5d are not limited to the shape. The insertion guides 5, 5a, 5b, 5c and 5d may be formed, for example, in a groove shape or may be configured with conduits for other endoscopes and medical instruments.

Note that, though the guide wall 71 is an inner wall of the insertion guide 5, 5a, 5b, 5c or 5d formed in an elongated pipe shape in the embodiment and the modifications, the guide wall 71 is not limited to the inner wall of the insertion guide 5, 5a, 5b, 5c or 5d. The guide wall 71 may be, for example, an inner wall of an insertion guide formed in a groove shape.

The present invention is not limited to the embodiment described above, and various changes, alterations and the like are possible within a range not departing from the spirit of the present invention.

What is claimed is:

1. An endoscope observation system comprising:
a scanning type endoscope comprising an emission optical fiber configured to emit emission light incident from an incident end, from an emission end, an actuator configured to cause the emission end to swing, a protection pipe with the emission optical fiber and the actuator attached inside, and a light receiving end configured to receive return light from an object and positioned at a distal end portion;
an insertion guide configured to guide insertion of the scanning type endoscope into the object along a guide wall; and
a holding member arranged between the scanning type endoscope and the guide wall and configured to hold the scanning type endoscope so that a position of the scanning type endoscope is not displaced by swinging of the emission optical fiber.

2. The endoscope observation system according to claim 1, wherein the holding member is configured with a vibration damping member configured to suppress vibration of the scanning type endoscope.

3. The endoscope observation system according to claim 1, wherein the holding member is arranged between an outer circumference of the scanning type endoscope and the guide wall.

4. The endoscope observation system according to claim. 1, wherein the holding member is provided on an outer circumference of the distal end portion.

5. The endoscope observation system according to claim 1, wherein the holding member is provided on the insertion guide.

6. The endoscope observation system according to claim 1, wherein the holding member is attachable and detachable.

7. The endoscope observation system according to claim 1, wherein the holding member is formed in a ring shape.

8. The endoscope observation system according to claim 1, wherein the holding member is attached to an attaching recess portion provided on the outer circumference of the distal end portion of the scanning type endoscope.

9. The endoscope observation system according to claim 1, wherein the holding member is attached to the guide wall.

10. The endoscope observation system according to claim 1, wherein the scanning type endoscope is held by the holding member and the guide wall.

11. The endoscope observation system according to claim 1, wherein at least three points of the scanning type endoscope are held by the holding member.

12. The endoscope observation system according to claim 1, wherein
the insertion guide is formed in an elongated pipe shape, and includes a bent portion which is bent in advance so as to be along an insertion route in the object; and
the guide wall is an internal wall of the insertion guide.

13. An insertion guide of an endoscope observation system holding a scanning type endoscope comprising an emission optical fiber configured to emit emission light incident from an incident end, from an emission end, an actuator configured to cause the emission end to swing, a protection pipe with the emission optical fiber and the actuator attached inside, and a light receiving end configured to receive return light from an object and positioned at a distal end portion, by a holding member so that a position of the scanning type endoscope is not displaced by swinging of the emission optical fiber, and guiding insertion of the scanning type endoscope into the object along a guide wall.

14. A holding member of an endoscope observation system arranged between a scanning type endoscope comprising an emission optical fiber configured to emit emission light incident from an incident end, from an emission end, an actuator configured to cause the emission end to swing, a protection pipe with the emission optical fiber and the actuator attached inside, and a light receiving end configured to receive return light from an object and positioned at a distal end portion and a guide wall of an insertion guide configured to guide insertion of the scanning type endoscope into the object, and holding the scanning type endoscope so that a position of the scanning type endoscope is not displaced by swinging of the emission optical fiber.
